(19) United States
(12) Patent Application Publication
(10) Pub. No.: US 2003/0154246 A1
(43) Pub. Date: Aug. 14, 2003

(54) Server for storing files

(76) Inventor: Ville Ollikainen, Vihti (FI)

Correspondence Address: YOUNG & THOMPSON, 745 SOUTH 23RD STREET 2ND FLOOR, ARLINGTON, VA, 22202

(21) Appl. No.: 10/321,532

(22) Filed: Dec. 18, 2002

(30) Foreign Application Priority Data
Dec. 18, 2001 (FI) 20012496

(51) Int. Cl. G06F 15/16; G06F 17/30; G06F 7/00

(52) U.S. Cl. 709/203; 709/231; 707/10

(57) ABSTRACT

The file server, especially the video or game file server, is composed of several hard disks These hard disks each contain at least one ring buffer as well as an storage are. When archiving a file, the file is split into file stripes, which are then distributed among several of the hard disk's storage areas. When the user requests a file, the file stripes are complied on an available ring buffer. Then isochronal real-time transmission from the ring buffer to the subscriber's terminal unit can begin right away. Once the file is transferred, a copy remains in the ring buffer. The hard disks may be grouped into nodes. The file server may be decentralised by positioning a portion of the nodes as remote nodes, which are geographically separated from other nodes. The file server can also be decentralised by making each fixed disk a part of a subscriber's terminal unit.

### FIELD OF THE INVENTION

The invention generally relates to storing files, especially video, audio, and game files, as well as transferring of stored files requested by a user to the user terminal. In particular, the invention relates to a video server storing files on disks from which they can be transferred isochronously as real-time multimedia data to the user's terminal through a communications network.

### BACKGROUND OF THE INVENTION

Typically, multimedia documents contain large amounts of audio and video material, graphics, text and data. Storing such documents requires a great storage capacity. When transferring multimedia documents, for example real-time video material on the video on-demand basis, the video is first retrieved from its storage location and then moved to a buffer from which it is then transferred to the user isochronously, i.e. with constant data rate.

Systems for storing multimedia files and distributing them to users are commonly referred to as video servers or file servers. Usually a file server comprises one or more storage disks and dynamic RAM memories functioning as buffers. The file server also includes software for controlling both the internal operations of the server and the network connections for downloading data to the users.

It is important that the data server is scalable, that is to say, it can be easily expanded as the number of users increases. A way for achieving this is to use a hierarchical topology; a centralised server with a mass memory storing the multimedia data, a LAN network and a least one buffer. The file requested by a user is copied from the central storage unit to the buffer, to be further transferred to the user. The transfer can be started while copying is still in process. Scalability is established by simply adding new buffers to the system. The maximum level for scalability depends on the capacity of the central server and the used network.

It is also possible to use a server cluster comprising several servers interconnected through a LAN network. In case the file requested by a user is not available at a certain buffer, it will be copied from another server via the LAN to another buffer. Scalability is established by increasing the number of servers.

Transfer speed of the LAN network sets a limit to the capacity of these kinds of file servers. This problem can be avoided by linking the servers in pairs through fixed high-speed connections. The disadvantage of this arrangement is the increased number of fixed lines, which makes system management more difficult. The advantage, on the other hand, is that a network video server consisting of several small servers is a very fault-tolerant system.

Present file servers for real-time video transfers are based on personal computers (PC), multiprocessing UNIX computers, parallel computers, or special hardware. U.S. Pat. No. 6,061,504 depicts a server consisting of easily available standard components. The operating system is conventional such as Windows NT or UNIX, and the server is managed with standard protocols like, for instance, the SNMP (Simple Network Management Protocol). Via the network the files can be accessed with a standard industrial file access protocol, e.g. NFS, and within the server with some file access protocol.

The video server of the US patent comprises several disk groups each of them including a cache memory, and stream servers connecting the disk groups into the communication network, enabling the transfer of video data between the disk groups and the network. The video file server also comprises a control server computer that, after a video request from a user, scans the disk groups to verify that they have sufficient capacity to fulfil the order and then commands one of the stream servers to perform the task in question. Both the stream and the control servers are normal computers (PC) readily available. They communicate through an internal data link. The computers are connected to the disk groups via one or more SCSI connections. The software in each stream server includes a real-time scheduler that times the isochronous, real-time tasks and general tasks.

The disk groups act as storages from which the requested files can be quickly delivered to the user's IP address. Dynamic, high capacity RAM memory cards have an essential role in the operation of the server. When a video file is retrieved from an external source to the server, it is in the first instance loaded to a RAM, then to the disk. Likewise, when delivering the requested file to a user, it is retrieved from the disk, copied to the RAM and then sent to the user's IP address via the communications network. Hence, RAM memories function as temporary storages when transferring files to the disks and to the users. Therefore, after receiving a video request from a user the system first checks if the requested file is already saved in one of the RAM memories. If this is the case, the file will be transferred to the user from the RAM. If not, it is first copied from the disk to the RAM from where it is then delivered to the user.

The actual mass storage of files in this US patent system is the tape drives to which files are saved from the disk groups as background processing When a user requests a video file it can thus be retrieved from the RAM memory, in which case the transfer is extremely fast, from one of the disks of the disk groups, which takes slightly more time, or from the tape drive which is noticeably slower.

The advantage of this video server is that it consists of standard components, software and protocols that are commonly available. The disadvantage is the relatively long response times, in particular when the requested files have to be loaded from the tape drive. Also, the numerous high capacity RAM memories that function as buffers increase the total price of the server.

European patent application No. 97926027.0 describes a multi-node video server based on the hyper cube architecture. The completely identical nodes are placed at the vertices of the hyper cubes. The nodes include a routing matrix, as well as a memory, that can be a hard disk. A user requesting a video file can be connected to any node. In case the requested file is not saved in the node to which the user is connected, it will be loaded from another node and transferred to the user node along the edges of the hyper cube. The edges consist of links connecting the nodes.

Once the file requested by the user has been transferred into the user node, it will be saved to the node's hard disk from which it can be downloaded to the user. After the file has been presented to the user, a copy of it remains on the hard disk of the node in question. When a user connected to another node requests the same file it will be loaded from this disk and transferred to the new user's node via the edges of the hyper cube. The file will also be saved onto the hard disk of the new node. Files replicated in this manner are also accessible to the other nodes, which means that the availability of the file is enhanced along with its demand. In practice, the video server can be an integrated computer with a Unix or Linux operating system.

The advantage of the server like this is that the more a file is requested, the larger is the number of the nodes to which it is copied. Thus, frequently requested files can be delivered to the users extremely quickly. The disadvantage, however, is that copying the same files to several locations occupies a lot of disk space. Replicating a file to the hard disks of at least two nodes is necessary for security reasons, as the disks also function as file storages. Naturally it is also possible to apply an external saving unit, e.g., a tape drive.

An objective of the present invention is to create method and a file server, which utilise a similar data replication as a server based on a hyper cube; the basic element is a personal ring buffer into which the data is copied simultaneously while being displayed. Another objective is to reduce the use of disk space by storing files within the server without maintaining several copies.

### BRIEF SUMMARY OF THE INVENTION

The objectives can be achieved with the invented method for storing files in the file server and transferring saved files to a user's terminal via a communications network, and by using the new file server type. The method and the file server make use of two facts relating to hard disks: firstly, the substantial increase in capacity and transfer speed and the improved price/capacity relation, secondly the fact that these developments have not resulted in similar improvements in the file seek time. The bottleneck in this case is the mechanism moving search head, which has not been made notably faster.

According to the method, the file that is to be stored is divided into file stripes, which are then allocated to the storage areas of several hard disks. Each disk is namely divided into a storage area and a ring buffer. Storing the stripes can be carried out with a normal fault-tolerant error correcting method, for example, the level 4 Data Stripping with Parity of the RAID system (Redundant Array of Independent Disks). Unlike the conventional stripping, the stripes are not allocated to each of the available disks but only to a part of them, The allocation varies from file to file, thus enabling, for instance, the disk space to be used as efficiently as possible.

Once the user has requested a file, the system begins to compile the stripes from the storage location to a free ring buffer. The compiling starts from the first stripe of the file, proceeding stripe by stripe towards the end. The isochronal transmission of the resulting consistent file from the ring buffer to the users terminal unit can be commenced almost immediately; a real-time transfer. The stripes are initially compiled into the ring buffer in order to create a sufficient amount of coherent video data and subsequently delivered to the user, while continuing to recover the following stripes from the storage's. Alternatively, it is also possible to compile the whole document in the ring buffer before transmitting it to the user.

A copy of the delivered file will be saved in the ring buffer. When the file is requested a second time, it will be transmitted directly from this location. Thus, if a copy of a requested file has been already saved at one of the ring buffers, the storage search phase can be skipped.

The method can be applied to a file server consisting of several server nodes, as defined in the first embodiment of the invention. Each node comprises at least one hard disk including at least one ring buffer with a sufficient capacity for saving a file, and a storage area with enough capacity to save the amount of data of several files. The nodes are interconnected through the internal network. All functions are controlled by the file server's control system, which manages the division of files into stripes and the allocation of these stripes to the storage areas of the hard disks. The hard disks can either belong to the same or different nodes. In the latter case the internal network handles the allocation of the stripes. In response to the user's request to have a file, the system ensures that the needed file is compiled into a ring buffer by transferring the necessary stripes from different storage areas via an internal network and/or within a node, and that the stripes compiled to the buffer are sent to the user's terminal through an exterior communications network. A copy of the sent file will be saved in the buffer.

It is possible to have a server with only one server node. In this event the node comprises several hard disks, all storing and compiling taking place within the node. As is the case with multi-node systems, a PC with a Linux or Unix operating system can function as a node.

According to the second embodiment, the file server can be distributed so that each node is a part of the user's terminal. Then data is transferred between the control system and the nodes via an exterior communications network that in this case is actually the same as the internal one.

In the third embodiment the file server can be divided into parts by placing some of the server nodes within a physical distance from the others. The server's control system manages the operations of these remote nodes as well, either through an internal or exterior network. This is a very cost-efficient due to increasing scalability. As the number of nodes at a certain position grows, they can be transformed into an independent file server by simply installing a required control system.

Another feature contributing to easy scalability is the selective allocation of the stripes to certain hard disks instead of distributing the stripes equally to all nodes. For achieving higher scalability one can just install new disks, as this does not necessitate the recompiling and reallocating of the data bulk, a quality of conventional RAID systems in which the data is divided equally between all disks.

### BRIEF DESCRIPTION OF THE DRAWINGS

In the drawings:

FIG. 1A depicts general architecture of the file server,

FIG. 1B depicts a ring buffer,

FIG. 2 shows elements in a single node,

FIG. 3 is a general description of retrieving and transmitting a file,

FIG. 4 depicts in more detail retrieving and transmitting a file

FIG. 5 is a flow chart delineating post-request processes

FIGS. 6 and 7 illustrates retrieving information from an exterior source

FIG. 8 is an embodiment of the file server

FIG. 9 is another embodiment of the file server

### DETAILED DESCRIPTION OF THE INVENTION

First embodiment of the invention

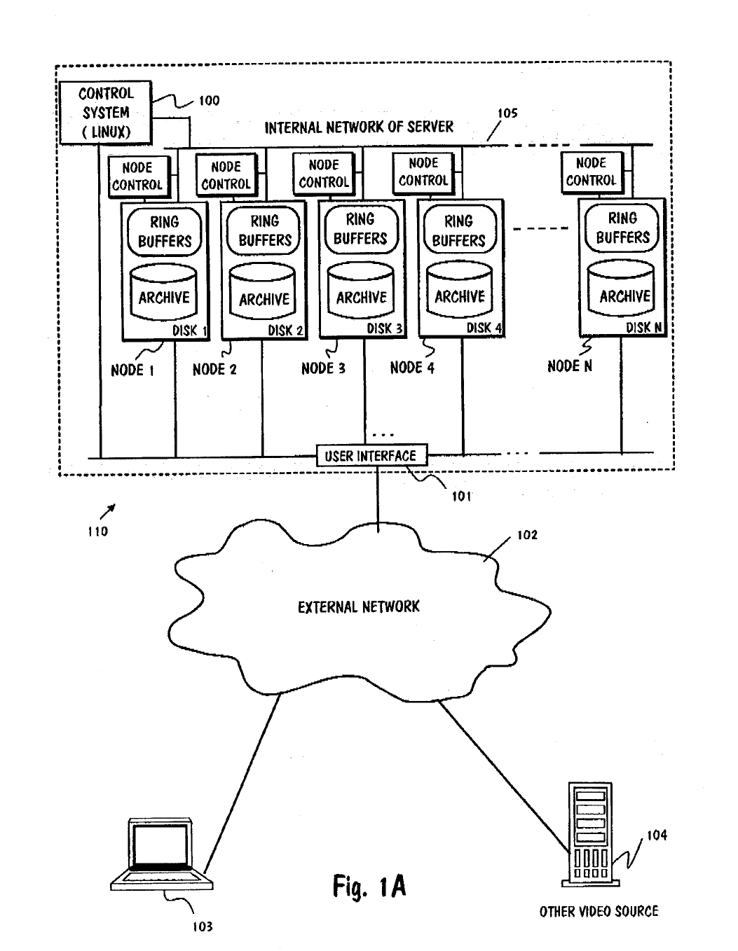

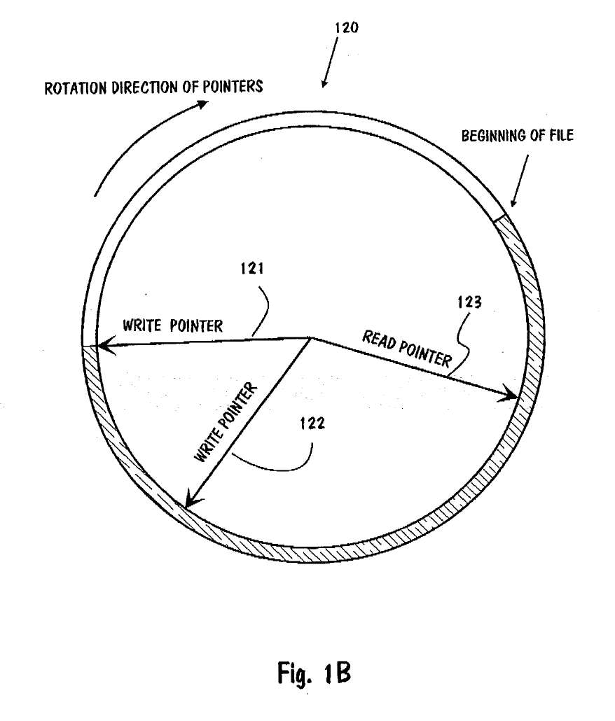

FIG. 1A depicts the basic elements of the file server. File server 110 is linked to the external network 102 which can be a computer network, e.g., the internet. From personal terminal unit 103 the user can contact file server 110, requesting a file that can be a video file. Transmission of a video file, normally a film, is isochronal, that is to say, of constant data rate. It is possible to load and save files to file server 110 from external source 104 through exterior network 102.

The file server consists of similar nodes: node 1, node 2, node 3 . . . node N. The basic element of each node is a hard disk that is typically divided into a ring buffer and a storage area. However, the server can also include nodes without buffers. A disk can feature more than one ring buffer. The nodes are interconnected via server's internal network 105 through which server's control system 100 manages interoperation of the nodes, i.e., the transfer of files between them. In addition, the network carries server's internal control signals. Control system 100 also manages the file server's network connections. It registers the file requests from user's terminal 103 and takes care of transmission of the file through user connection 101 to the user terminal.

Each node also includes a node control, which is responsible for data transfers within the node, contacts with other nodes, and for calculating the parity necessary for splitting and compiling of files. In addition, it may manage the conversion of files from one presentation format to another. Conversion is required if the video file has been stored in a format that the user's terminal cannot process. Once converted, the material can be saved to the server in the same way as the original data.

As said before, the basic element of each node is a high capacity hard disk. A large part of the disk's saving capacity is reserved for storing files, a smaller space being left for the ring buffer. The number of disks in a node or the number of nodes in a file server is not limited; they may be up in the dozens.

FIG. 1B illustrates a ring buffer. Ring buffer 120, of which there can be several in one hard disk, functions as follows:

Upon a user's request, the file server retrieves the stripes of the video file from the storage areas, commencing with the first stripe and proceeding stripe by stripe towards the end of the file. Write pointer 121 feeds the resulting complete video file to ring buffer 120. Once a sufficient part of the file has been compiled in the buffer, read pointer 122 starts reading the file, naturally from the beginning on. The file read by pointer 122 is being transmitted to the user's terminal via the network. Another read pointer 123 helps to transfer the file within the server: if necessary, the file can be copied to a ring buffer of another node. The file server may have a pre-set to a ring buffer of another node. The file server may have a pre-set internal minimum transfer rate or the rate can be defined specifically for each file type. This minimum speed equals or exceeds the maximal real-time file transfer rate required for the viewing of a certain type of file. It is beneficial for the functionality of the server if the pointer speeds are such that the read pointer can move fast enough to enable a real-time transfer to the user. Therefore the writing speed has to be at least the same, preferably greater, as the reading speed. This ensures a flawless transmission to the user without extra buffering of data in, for example, the user's equipment. A reduced need for buffering results in shorter response times.

Reference is again made to FIG. 1A. The storage of the file server consists of the storage areas of all the hard disks. This storage comprises all the multimedia materials offered to the users. However, the files have not been saved to the storage areas as one entity; instead, they have been divided into the storage areas of the disk drives of various nodes. As said before, storing can be carried out with a normal fault-tolerant error correcting principle, e.g. the level 4 Data Stripping with Parity of the RAID system. The file to be stored is split into stripes that are then allocated to the storage areas of different hard disks. The parity bits, on the other hand, are all saved in one hard disk. Still, contrary to the RAID, which utilises a fixed division, the invention allocates the file stripes dynamically: they can be freely placed on the storage area(s) of any disk(s), positioning of each stripe being controlled separately. Control system 100 manages the splitting and division of the files, as well as their restoration. This function can be performed by a normal, commercial RAID program or by hardware. The actual task of splitting and dividing is carried out by the management system of the node in whose ring buffer the file to be stored is located.

When user's terminal 103 transmits a request to receive a video film, control system 100 connects the user to a free ring buffer of a server node. Then the control system controls compiling of the file stripes scattered around the storage areas into the buffer. Stripes are compiled in order from the first stripe to the last. In the real-time transfer already compiled data is being transmitted to the user through an exterior network, while the node's management system is compiling the next stripes in the buffer. In case the file stripes cannot be compiled at the rate required for the real-time data transfer, it is possible to assemble enough stripes to the buffer to secure an non-interrupting transmission before commencing the transfer. Thus, the ring buffer always contains a certain minimum amount of file stripes at the beginning of the broadcast, which ensures that the transfer to the user will occur at the speed required by the video format despite possible hindrances in the compilation of the stored stripes. This corresponds with a situation in which the speed of the read pointer exceeds that of the write pointer, cf. FIG. 1B.

In both events the file will be saved in the ring buffer after the transmission. This means that there exists two copies of one file, one scattered in the storage and the other as a whole in the buffer. Should another user request the same file, it can be transmitted directly from the buffer, either in real-time or non real-time.

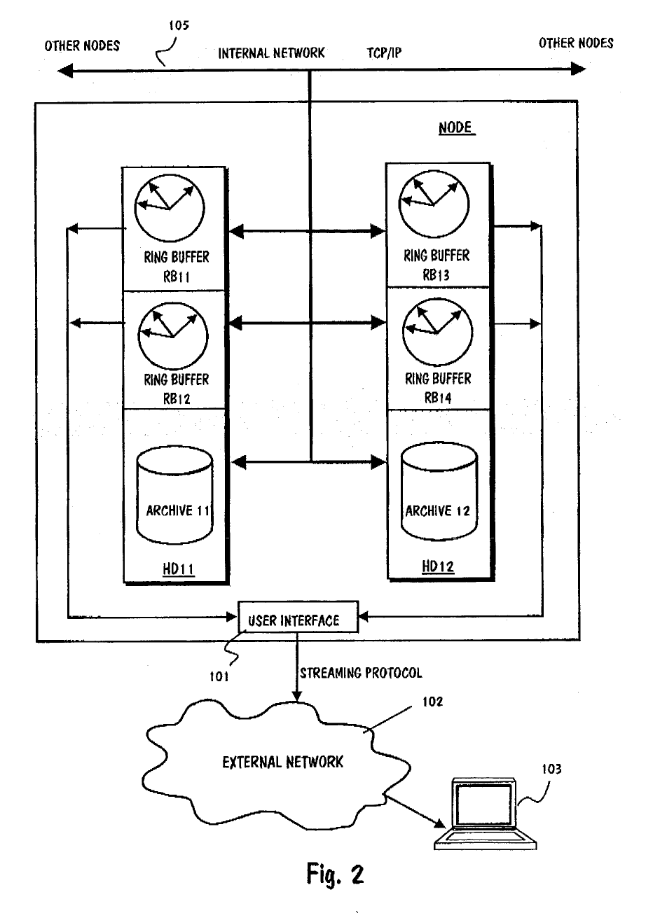

FIG. 2 shows the structure of a node in more detail. Our example node comprises two hard disks: Disk HD11 features storage area A11 and ring buffers RB11 and RB12. Disk HD12 has storage area A12 and ring buffers RB13 and RB14. Both the ring buffers and storage areas are connected to the server's internal network 105 which can be, for example, an Ethernet network based on the TCP/IP protocol. User's terminal 103 can only be connected to the buffers, whereas the possibility to access storage areas is allowed only to other nodes of the file server and to the control system. The number of ring buffers a node determines the number of users it can serve simultaneously. In FIG. 2 that would be four. The ring buffer could be large enough to fit the largest presentation available in the video server. A presentation refers to a movie or a part of a long lasting movie. In the case of a DVD film the buffer's size could be 8.5 GB that is the capacity of a one-sided two-layered DVD-9 disk and roughly the equivalence of a long movie.

DVD films are normally encrypted with the so-called CSS method in which the files are decrypted in the terminal unit for presentation. A similar principle can be applied in the file server presented in this application.

Assuming that in order to display a real-time DVD film a ring buffer must transmit data at a speed of 10 Mb/s, the four-buffer node in FIG. 2 could send a stream of 40 Mb/s.

If the node had four hard disks, each of which comprised four ring buffers, the speed of the data stream fed to the users would reach 160 Mb/s. As the node also serves other nodes, a certain capacity has to be reserved for them, e.g., 60 Mb/s. Thus the total data rate transmitted by the node would be 220 Mb/s. These kinds of speeds can be relatively easily achieved by present, commercially available hard disks and software.

Let us assume that terminal 103 sends a request to have a film that is not available in any of the ring buffers of the video server. The file server's control system discovers that a large part of the demanded film resides in storage areas A11 and A12 of hard disks HD11 and HD12, respectively (FIG. 2). The user is guided to a free ring buffer of this node, for instance to RB11, to which the file stripes, divided according to the RAID principle and allocated to the hard disks of the file server's nodes, will then be compiled. Stripes that are at the storage area of the hard disks of the node in question will be directly transferred to the ring buffer. Stripes from other nodes will be imported through internal network 105. In a real-time data transfer file stripes will be sent to the address of user's terminal 103 as they reach the buffer, in a non-real-time transfer a certain amount of stripes will be compiled into the buffer before commencing the transmission. After the whole file has been transferred, a copy of it will remain at the buffer RB11.

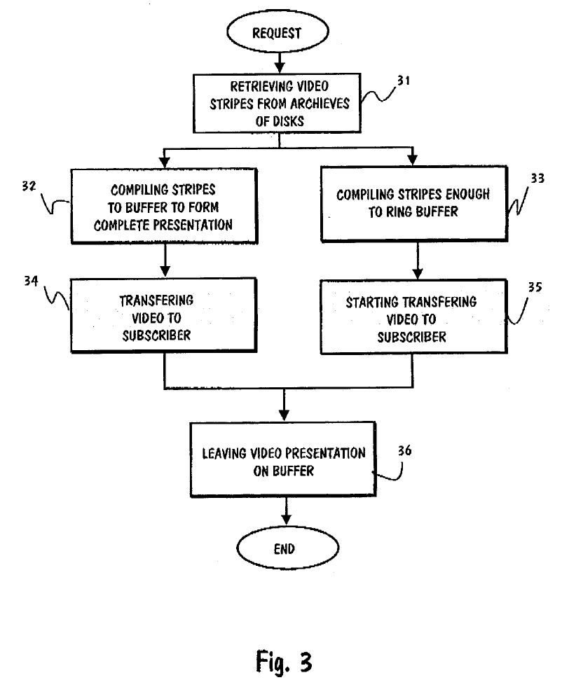

The block diagram in FIG. 3 illustrates two different methods of delivering a video to the terminal. Having received a request for a video from the terminal, the file server starts to retrieve the stripes of the file from the storage areas of different hard disks (phase 31). It is possible to compile the stripes into a ring buffer chosen by the system as a full file (phase 32) before commencing the transmission to the user (phase 34). Alternatively, the transmission can be started after having gathered a sufficient amount of stripes into the buffer (phase 33), while still receiving the latter part of the video from the storage areas (phase 35). In each case, a copy of the sent video, which has been sent to the subscriber, will be saved in the ring buffer (phase 36).

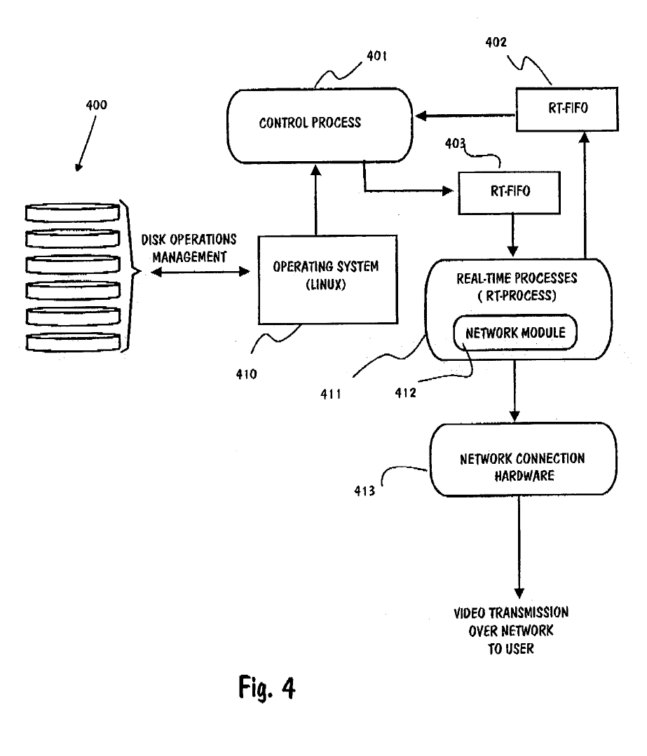

FIG. 4 presents a possible scheduler that would be realisable with a real-time operating system. At the present t, a host of different operating systems are available. However, several of these have deficiencies as far as openness, standardising, support, efficiency and real-time performance are concerned. Many operating systems are UNIX-based. Among these, the LINUX-system in particular has the benefit of excellent stability, efficiency, free open code and a considerable user base. Therefore the nodes of the file server of the hereby-presented invention can be personal computers (PC) operating on the Linux system. The non real-time Linux does nonetheless have a number of shortcomings that make the creation of a real-time scheduler difficult. For instance, the real-time servicing of interrupts is unmanageable due to a delay in interrupts servicing when Kernel is busy in executing a higher priority function. Therefore, a LINUX system is ineffectual as a real-time system as such because it fails to meet the stringent requirements set for isochronal real-time data transmission.

It is known that LINUX has been supplemented by creating a layer that performs real-time (RT) functions between the operating system and the hardware. This RT-LINUX is produced using an emulation-software layer, which handles the interrupts requested by the hardware. This RT-layer is depicted in FIG. 4 by module 411, “real-time processes”. The data transmission between the real-time processing layer and control process 401 occurs through buffers 402 and 403. The buffers can be real-time FIFO's or else they can be accomplished through shared memory. On the other hand, real-time layer 411 communicates with network access hardware 413. The aforementioned is a known RT-LINUX-principle.

Known real-time processes layers are essentially unable to use LINUX Kernel Services, such as disk-I/O and network connections. For this reason, this invention requires a specific network-module in the real-time layer for sending a video-stream. This module is referred to in FIG. 4 by reference number 412. This network-module gets its input from user specific modules (not shown in the figure). A user specific service can be implemented using RT-LINUX, e.g. so that there can be a server module in the real-time layer for each user, which will accomplish the data transfer to the user using the network-module 412. For these modules, a small buffer is deserved in the central memory that gets filled from a disk-I/O process residing on the actual LINUX side. In this case the disk-I/O process manages the server application in a controlled manner, as well as simultaneously managing almost all LINUX disk functions. In doing so, it is possible to utilise the already effective disk management of LINUX without needing to rewrite disk drivers.

Still referring to FIG. 4, when a user has requested control process 401 to deliver a certain movie, the control process will request the operating system to assemble the file stripes of the movie that were stored on various hard disks 400 to the user's buffer. The operating system fetches the file stripes of the requested movie to the central memory in right sequence, from where they are directed further to the ring buffer that the user is connected to. The real-time processes layer 411 transfers the complied video from the ring buffer to the network-module 412 and through the network connection hardware 413 to the address of the terminal unit belonging to the user who requested the video.

If the internal and exterior networks are separated from each other, as illustrated in FIG. 1, the node's LINUX can be controlled in a standard way through the internal network, while the exterior network is reserved for data transmission only. It is also feasible to use only one network card and a single network when the internal and exterior networks are one and the same network. In this case, the driver of the network card can be programmed onto the real-time side, when all the network traffic of the actual LINUX is routed through network module 412 which resides in the real-time layer.

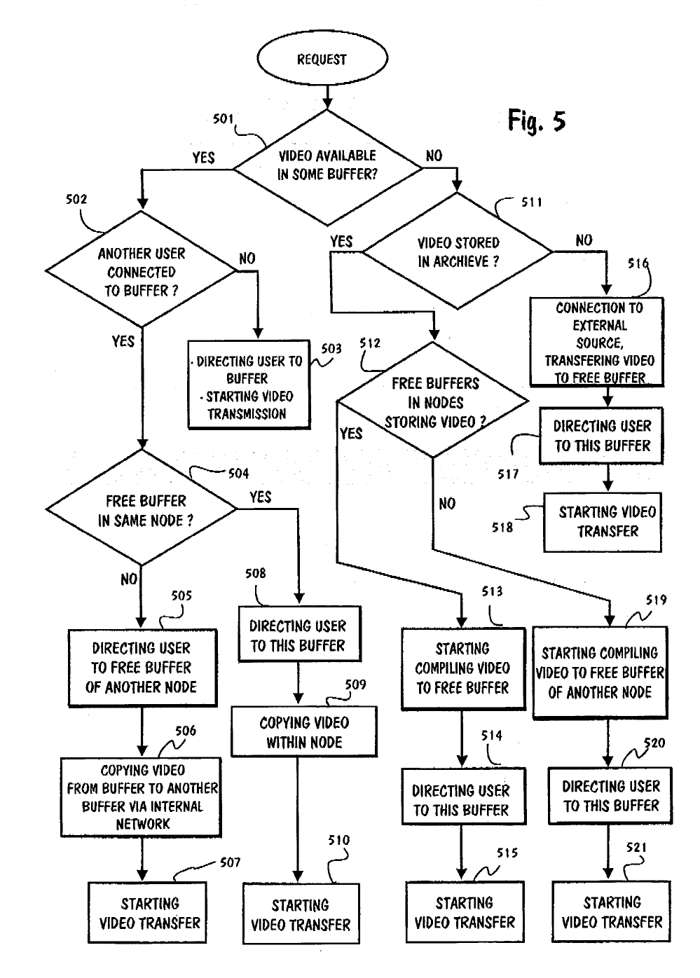

FIG. 5 illustrates, on a general level, events beginning with the user's requests to acquire a video until the start of video transmission. When the system responds to a user's video request, it first examines whether the assembled video already exits in some ring buffer (phase 501). If this fails, the system checks if there are any video stripes in the hard disks storage areas (phase 511). If so, it determines whether there are any ring buffers available in the nodes (phase 512). If the video does not exist in the storage, the system establishes a connection with an exterior source and begins video transmission from the source to an available buffer (phase 516). The user is then directed to this buffer (phase 517) and the transmission of the video to the user is initiated (phase 518).

If buffers are available in the node that has stored the video, video assembly to one such available buffer begins (phase 513), the user is then directed to this buffer (phase 514) and the transmission of the video is initiated. If the nodes in which the videos are stored do not have available buffers, a node with an available buffer is sought and video assembly to this buffer is initiated (phase 519). The user is then directed to this buffer (phase 520) and video transmission to the user is initiated (phase 521).

Let's return to phase 501. If the requested video is found in the file server's ring buffer, the ring buffer is examined to see if there is another user connected at that moment (phase 502). If there is no other user connected to this ring buffer, the user is directed to it and the video transfer is initiated (phase 503). If there is another user in this ring buffer, then the control system determines whether there is another available ring buffer in the same node (phase 504). If an available buffer in the same node is found, the user is directed to this buffer (phase 508), file replication is initiated (phase 509), and video transfer begins (phase 510). If there is no available ring buffer in the same node, the user is directed to another node with an available ring buffer (phase 505). The replication of the requested file is initiated over the internal network from the ring buffer that had stored to video to this buffer (phase 506), and video transmission to the user begins.

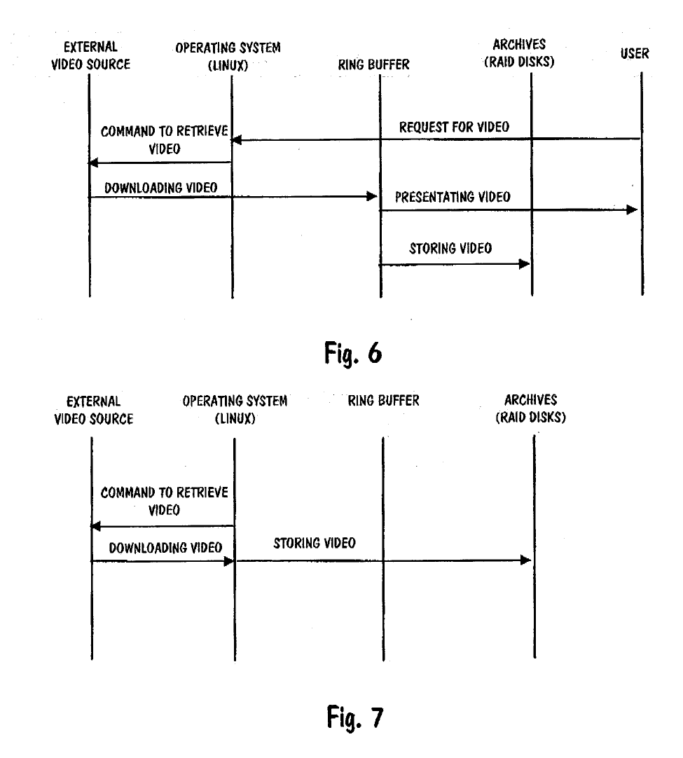

If the user's requested video file is not found in any of the server's ring buffers or storages, it must be located from an exterior source, as illustrated in phase 516 in FIG. 5. Referring back to FIG. 6. When the control system receives a video request from the user that is not available in the file server, the control system commences a video search function from the exterior video source. The control system establishes a connection to the exterior video source, which sends the video, which the control system then directs to the ring buffer to which the user was directed. The presentation of the video commences either in real-time or non-real-time. After the presentation, a copy of the file exists in the ring buffer, from which it can be stored to a different hard disk in the file server according to error correction principles in the above-depicted manner.

In certain cases, i.e. due to resource allocation or fault situations, it might be reasonable to proceed in a way that differs from the above-described and choose another branch in the decision tree. For example, if the server is geographically distributed and the requested file is far in some part of the server, then the file is fetched from that server part.

The operator of the file server can also choose to look for a video in the external source, which can then be offered to users. In this case, the control system establishes contact with the desired exterior video source and requests the video. The exterior video source can send the video to the file server, which storage's it into the hard disks of different nodes. Not until a user has requested this specific video is it complied in the ring buffer, after which a copy also exists in that ring buffer. It is also possible to retrieve the video from the exterior source initiated by an exterior control signal. In this case, the exterior source sends a signal to the file server, which in return launches a file search.

The second implementation of the invention

It is also possible to implement the file server in such a way that the internal and exterior networks are physically the same network, perhaps even driven through the same network card. The fact that nodes are addressed with IP-addresses allows the nodes to be distanced from each other physically and indeed allows each node to be integrated into a set-top-box. The set-top-box is a unit in the user premises, which facilitates digital television signal reception and presentation on a television screen. However, a part of the boxes may reside in the operator's premises. It is a good way to start the service and add user's boxes according to the need.

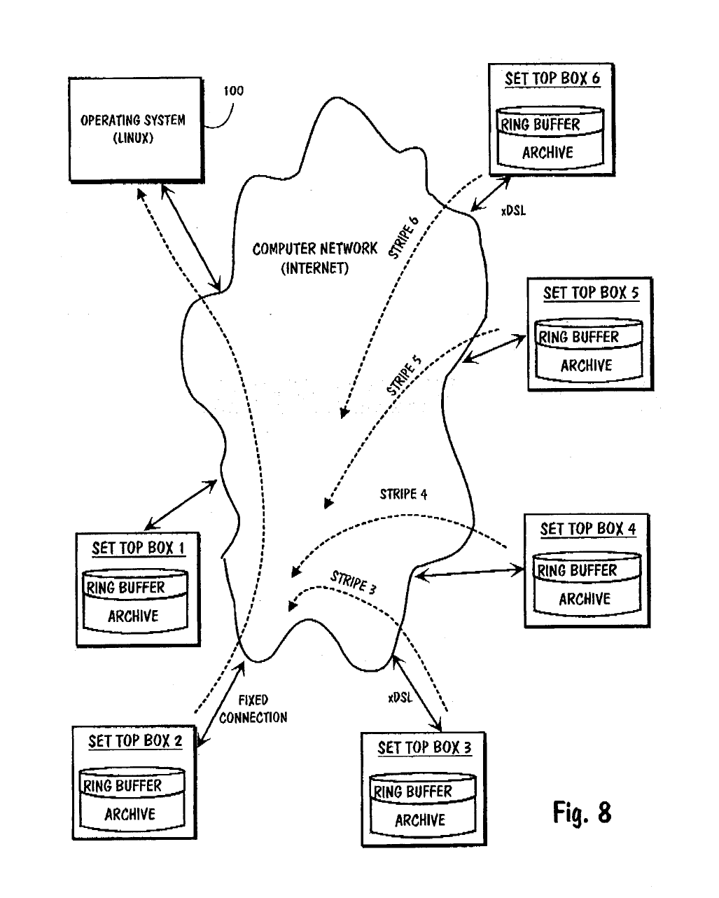

FIG. 8 illustrates such a case. It represents a set-top-box, which is on the premises of six different users, each of whom have a network connection. The software in the set-top-box (not shown) communicates with centralised control system 100 residing somewhere in the network. There is a hard disk in each set-top-box, which has a storage area and a ring buffer. Thus, a distributed file server consists of control system 100, set-top-boxes with hard disks and software, as well as the transmission network connecting all these elements. Here, the file server's video is split and distributed along different storage areas in hard disks of set-top-boxes. Of course, the control system has precise knowledge of the location of each video stripe. The distributed file server system, as shown in the picture, of course requires sufficiently speedy broadband connections between the set-top-boxes. For this purpose an xDSL or comparable fixed connection, with sufficient bandwidth upstream as well, can be employed.

Let's assume, for example, that the user, in whose premises set-top-box 2 is located, wants to watch a certain movie video. With the help of the user's set-top-box, the user can establish a connection to control system 100 and find a directory of all available movies. The user then chooses a certain movie. Then, the control system examines which storage areas in the hard disks of the set-top-boxes contain the stripes of the movie in question. The control system finds that the file stripes are scattered into the storage areas of set-top-boxes 3, 4, 5 and 6. The control system commands the set-top-boxes to send these video file stripes to set-top-box 2, which receives the stripes into its ring buffer. The set-top-boxes that send the file stripes do so by sending the storage stripes directly from the storages without directing them through the ring buffers. In this case, it might be difficult to achieve real-time video presentation, so the set-top-box might have to assemble the entire video in its ring buffer before presenting the video. When the user has viewed the video, a copy of it remains in the ring buffer. Knowledge of this goes to control system 100 and if another user requests this particular movie, it is available immediately from the ring buffer of set-top-box 2, thus making it unnecessary to reassemble it from video stripes again. Real-time presentation requires sufficient transmission rate from the box to the network.

Because the video file stripes are distributed to the hard disks of several set-top boxes according to parity principles, one set-top-box can be out of use and the entire video file can still be complied from the recordings of other set-top-boxes,

Usually several set-top-boxes are in the switched-off state. In which case, the control system 100 can “wake it up” to the active state, with, for example, the familiar Wake on LAN-method. The Wake on LAN technique is a technique, developed by the Intel-IBM Advanced Manageability Alliance. Even when a set-top-box is in the switched-off state, its Ethernet-adapter receives its operating voltage. It constantly monitors the network and searches for wake up-packages that are addressed to it. When it detects one, it alerts the set-top-box, which then switches the power on. The unit is then ready to be an active part of the file server.

What is noteworthy about the second implementation of the invention is that even though the video storage is located in the end users' set-top-boxes, the single video files are there not in their entirety, which is beneficial as far as the storage's data security is concerned. In addition, if the files are encrypted, e.g. with the CSS method used with DVD film, the data security of the content in the ring buffers is at least equivalent to that of the DVD discs.

The third implementation of the invention

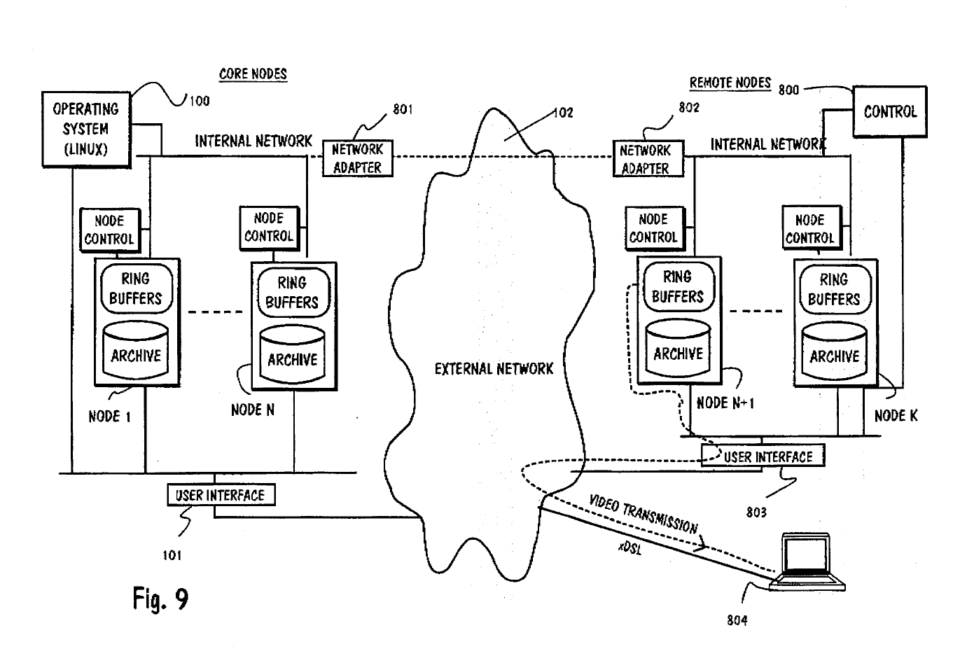

FIG. 9 represents another viable way to implement a distributed file server. In this case, the file server consists of core nodes, node 1 . . . node n, which are located close to each other physically and are connected to each other through the internal network, as previously delineated. The main parts of the control system 100 are also located in association with the core nodes. A set of remote nodes, node n+1 . . . node k, which are geographically remote, for instance in another part of town or another city, are interconnected through the remote node of the internal network. The internal networks of the core nodes and remote nodes can form a virtual private network (VPN) or the networks can be connected to each other with some other fixed connection. Archiving can be actualised by evenly scattering the movie's file stripes to the storage area of all the nodes, or else by locating frequently watched video files in the storage area of both the core node and the remote node. While expanding the hardware, an independent server can later be formed from the remote nodes.

Let's assume that the user of terminal unit 804 wants to watch a certain movie video. The user can connect to control system 100 of the terminal unit, which determines that the requested video is entirely stored in the remote node's storage area. Control system 100 delegates the transfer tasks to remote node control 800. It states that the requested video movie is stored in its entirety to the storage area of the node n+1, then the assembly of file stripes in the ring buffer of the node in question begins, allowing that the ring buffer is available. If it is unavailable, assembly occurs in another remote node that has an available ring buffer. When the assembly is complete, the video is delivered further through user access 803 to the exterior network and through it to the user's terminal unit 804. In the instance of real-time data transfer, transfer of the file stripes is initiated isochronically as they are complied from the storage area.

While the stripes are compiled the compilation can be watermarked in order to prevent misuse of the file. The watermark tells in whose box the file has been compiled. Thus if illegal copies are found it can be find out who has opened the box for making copies of the file. Also the copies in other nodes can be watermarked.

Three different implementations have been portrayed. These implementations are not mutually exclusive. In fact, a file server can be realised as a combination of these three.

1. A file server having disks for saving files, wherein files can be transferred to subscriber's terminal units through a transmission network, characterised in that it includes:
a group of hard disks, each disk including at least one ring buffer having enough capacity to save one entire file, as well as an storage area having enough capacity to save data of several files,
an internal network to which the ring buffers and storage areas are connected,
the file server being adapted under supervision of a control system, to:
store files by splitting the files into file stripes and then distributing through the internal network the stripes to the storage areas of a plurality of the hard disks, and in response to the subscriber's request to have a file
compile the requested file into one ring buffer by transferring through the internal network the file stripes from the different hard disk's storage areas to said ring buffer and
send the file stripes compiled into the buffer to the subscriber's terminal unit.

2. The file server according to claim 1, characterised in that the hard disks are grouped into nodes, each of which consisting of at least two hard disks and in that data transmission between the nodes takes place via the internal network.

3. The file server according to claim 1, characterised in that the control system manages the distribution of the file stripes to the hard disk's storage areas according to the file in question, wherein the file stripes are distributed to only a portion of the hard disks.

4. The file server according to claim 1, characterised in that the control system assures that the file compiled in the ring buffer stay preserved in the ring buffer, wherein the file is immediately available to other terminal units.

5. The file server according to claim 2, characterised in that the file server is distributed by allocating a portion of the nodes as remote nodes, which are geographically separated from other core nodes, and in that the internal networks of the remote nodes and core nodes are solidly connected to each other.

6. The file server according to claim 2, characterised in that the file server is distributed by allocating a portion of the nodes as remote nodes, which are geographically separated from other core nodes, and in that the data transmission between remote nodes and core nodes occurs through an exterior data transmission network.

7. The file server according to claim 1, characterised in that the control system manages the transfer of the file stripes from the ring buffer to the terminal unit white file stripes are concurrently complied in the ring buffer, wherein the file assembly and transfer occur at real-time speed.

8. The file server according to claim 1, characterised in that the control system ensures that transfer of the file stripes from the ring buffer to the terminal unit begins only after a sufficient amount of file stripes are in the ring buffer, wherein the terminal unit is able to present the entire file without interruption.

9. The file server according to claim 1, characterised in that the file server is distributed so that each fixed disk is a part of user's terminals, and that the data transmission between the control system and fixed disks as well as the data transmission between the fixed disks occurs through the transmission network.

10. The file server according to claim 1, characterised in that the control system is either Unix or LINUX.

11. The file server according to claim 2, characterised in that each node is a general purpose personal computer (PC) in accordance with industrial standard.

12. A method for archiving files in a file server and transferring the stored file via a network to a subscriber's terminal unit, characterised by the steps of:
splitting the file to be stored into file stripes,
distributing the file stripes among several of hard disks' storage areas, and in response to the subscriber's request to receive a file
compiling the file stripes of the requested file onto one of the ring buffers formed on the hard disks, transferring the complete file compiled from the consecutive file stripes from the ring buffer to the subscriber's terminal unit through the transmission network.

13. The method according to claim 12, characterised in that the complete file compiled from the consecutive file stripes is saved onto the ring buffer.

14. The method according to claim 12, characterised in that the distribution of the file stripes is executed by filling the hard disk's storage areas unequally, wherein the file is only distributed into the storage areas of a few hard disks.

15. The method according to claim 12 or 13, characterised in that the transfer of the file compiled from the consecutive file stripes is initiated immediately and continued at the same rate as file stripes are retrieved from the hard disks' storage areas.

16. The method according to claim 12 or 13, characterised in that such amount of consecutive file stripes are complied in the ring buffer before transmission to the subscriber's terminal unit so that the subscriber's terminal is able to present the file without interruption.

17. The method according to claim 12 or 13, characterised in that consecutive file stripes are complied in the ring buffer to form the complete file before transferring.

18. The method according to claim 12, characterised in that the file server's hard disks are formed as nodes, each of which consists of at least two hard disks including their ring buffers and storage areas.

19. The method according to claim 18, characterised in that file stripes are complied principally onto the free ring buffer of such a node containing the requested file's file stripes in its storage area.

20. The method according to claim 13, characterised in that the requested file is transferred to the client without searching storage areas if the file is already saved in some ring buffer.

21. The method according to claim 12, characterised in that the transfer of file stripes to the storage and from the storage to the ring buffer is executed through the file server's internal transmission network.

22. The method according to claim 13, characterised in that the complete file is watermarked.
